(19) United States
(12) Patent Application Publication
(10) Pub. No.: US 2026/0237941 A1
(43) Pub. Date: Aug. 13, 2026

(54) Terminal Module, Connector, Mating Terminal Module and Mating Connector

(71) Applicants: Tyco Electronics (Dongguan) Ltd., Dongguan City (CN); TE Connectivity Solutions GmbH, Schaffhausen (CH); Tyco Electronics (Shanghai) Co., Ltd., Shanghai (CN)

(72) Inventors: Hongjian (Neil) Ni, Shanghai (CN); Michael Streckewald, Middletown, PA (US); Yongfeng Li, Dongguan (CN); Qiaoli (Cherie) Chen, Shanghai (CN); Randall Robert Henry, Middletown, PA (US); David (Xinjie) Zhang, Shanghai (CN); Leo (Lizhou) Li, Shanghai (CN); Tim (Zhaohai) Xue, Shanghai (CN)

(73) Assignees: Tyco Electronics (Dongguan) Ltd., Dongguan City (CN); TE Connectivity Solutions GmbH, Schaffhausen (CH); Tyco Electronics (Shanghai) Co., Ltd., Shanghai (CN)

(21) Appl. No.: 19/532,411

(22) Filed: Feb. 6, 2026

(30) Foreign Application Priority Data
Feb. 8, 2025 (CN) 202510140890.4

(51) Int. Cl. H01R 13/658

(52) U.S. Cl. CPC H01R 13/658

(57) ABSTRACT

A terminal module includes an insulator, a pair of grounding components fixed to the insulator and spaced opposite each other in a width direction of the insulator, and a plurality of pairs of high-speed signal terminals fixed to the insulator and arranged in a row along a length direction of the insulator. A row of the high-speed signal terminals is located between the grounding components and is spaced apart from the grounding components by a predetermined distance in the width direction. Each of the grounding components includes a plurality of grounding spring pieces corresponding to the plurality of pairs of high-speed signal terminal. The grounding spring pieces are arranged in a row along the length direction of the insulator. Each of the high-speed signal terminals has a contact spring arm located between a pair of the plurality of grounding spring pieces that are opposite each other in the width direction.

### CROSS-REFERENCE TO RELATED APPLICATION

This application claims the benefit of the filing date under 35 U.S.C. § 119(a)-(d) of Chinese Patent Application No. 202510140890.4, filed on Feb. 8, 2025.

### FIELD OF THE INVENTION

The present invention relates to a terminal module and a connector comprising the terminal module. In addition, the present invention also relates to a mating terminal module for mating with the terminal module and a mating connector for mating with the connector.

### BACKGROUND OF THE INVENTION

In existing technology, wire end connectors typically include a housing, a circuit board located within the housing, and multiple cables electrically connected to the circuit board. The board end connector that matches with the wire end connector commonly includes an insulation shell and terminals set in the insulation shell. The terminals have contact spring arms that make electrical contact with the circuit board and soldering pins for soldering to the circuit board. The existing wire end connectors and board end connectors have high contact impedance and severe crosstalk, which cannot meet the requirements of higher speed signal transmission.

### SUMMARY OF THE INVENTION

A terminal module includes an insulator, a pair of grounding components fixed to the insulator and spaced opposite each other in a width direction of the insulator, and a plurality of pairs of high-speed signal terminals fixed to the insulator and arranged in a row along a length direction of the insulator. A row of the high-speed signal terminals is located between the grounding components and is spaced apart from the grounding components by a predetermined distance in the width direction. Each of the grounding components includes a plurality of grounding spring pieces corresponding to the plurality of pairs of high-speed signal terminal. The grounding spring pieces are arranged in a row along the length direction of the insulator. Each of the high-speed signal terminals has a contact spring arm located between a pair of the plurality of grounding spring pieces that are opposite each other in the width direction.

### BRIEF DESCRIPTION OF THE DRAWINGS

Features of the present invention will become more apparent by describing in detail exemplary embodiments thereof with reference to the accompanying drawings, in which:

FIG. 1 shows a three-dimensional schematic diagram of a connector according to an exemplary embodiment of the present invention;

FIG. 2 shows an exploded schematic diagram of a connector according to an exemplary embodiment of the present invention, without a display screen cover;

FIG. 3 shows a three-dimensional schematic diagram of a terminal module of a connector according to an exemplary embodiment of the present invention;

FIG. 4 shows a schematic plan view of the terminal module of a connector according to an exemplary embodiment of the present invention when viewed from one end;

FIG. 5 shows an exploded schematic diagram of the terminal module of a connector according to an exemplary embodiment of the present invention;

FIG. 6 shows an exploded schematic diagram of the grounding element and reinforcement strip of the terminal module of the connector according to an exemplary embodiment of the present invention;

FIG. 7 shows a transverse sectional view of a terminal module of a connector according to an exemplary embodiment of the present invention;

FIG. 8 shows a transverse exploded sectional view of a terminal module of a connector according to an exemplary embodiment of the present invention;

FIG. 9 shows a longitudinal sectional view of a terminal module of a connector according to an exemplary embodiment of the present invention;

FIG. 10 shows a longitudinal exploded sectional view of a terminal module of a connector according to an exemplary embodiment of the present invention;

FIG. 11 shows a three-dimensional schematic diagram of a connector and a mating connector according to an exemplary embodiment of the present invention;

FIG. 12 shows a perspective sectional view of a connector and a mating connector according to an exemplary embodiment of the present invention;

FIG. 13 shows a plan sectional view of a connector and a mating connector according to an exemplary embodiment of the present invention;

FIG. 14 shows a plan sectional view of a connector and a mating connector according to an exemplary embodiment of the present invention, where the high-speed signal terminal has just made electrical contact with the high-speed mating signal terminal and the grounding spring has not yet made electrical contact with the conductive shield;

FIG. 15 shows a plan sectional view of a connector and a mating connector according to an exemplary embodiment of the present invention, wherein the connector and the mating connector have been mated together;

FIG. 16 shows a three-dimensional schematic diagram of the high-speed signal terminal and low-speed signal terminal of a connector according to an exemplary embodiment of the present invention;

FIG. 17 shows a schematic plan view of the high-speed signal terminal and low-speed signal terminal of a connector according to an exemplary embodiment of the present invention;

FIG. 18 shows a schematic plan view of the high-speed signal terminal and low-speed signal terminal of a connector according to an exemplary embodiment of the present invention, as well as the high-speed matching signal terminal and low-speed matching signal terminal of a mating connector. The first low-speed signal terminal and the first low-speed matching signal terminal used for electrostatic discharge protection have just made contact, while the signal terminals for other functions have not yet made electrical contact;

FIG. 19 shows a perspective view of a connector and a mating connector according to an exemplary embodiment of the present invention when viewed from the front side;

FIG. 20 shows a three-dimensional schematic diagram of a connector and a mating connector according to an exemplary embodiment of the present invention when viewed from the rear side;

FIG. 21 shows an exploded schematic diagram of a mating connector according to an exemplary embodiment of the present invention;

FIG. 22 shows a three-dimensional schematic diagram of the mating terminal module and low-speed signal terminal module of a mating connector according to an exemplary embodiment of the present invention;

FIG. 23 shows an exploded schematic diagram of the mating terminal module of a mating connector according to an exemplary embodiment of the present invention;

FIG. 24 shows a three-dimensional schematic diagram of the mating terminal module of the mating connector according to an exemplary embodiment of the present invention when viewed from the back; and

FIG. 25 shows a three-dimensional schematic diagram of the mating terminal module of a mating connector according to an exemplary embodiment of the present invention when viewed from the back, where one shielding connector has not yet been soldered to the shielding layer of a row of high-speed signal cables.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

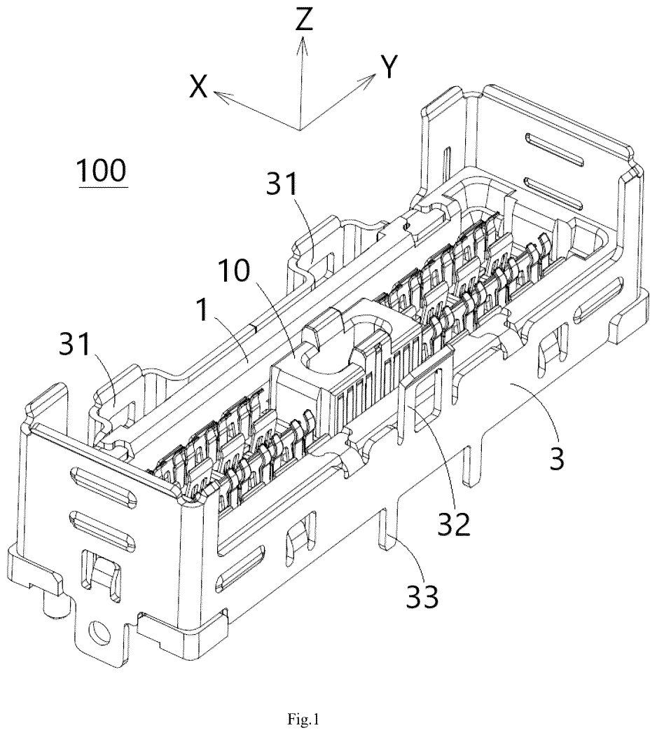

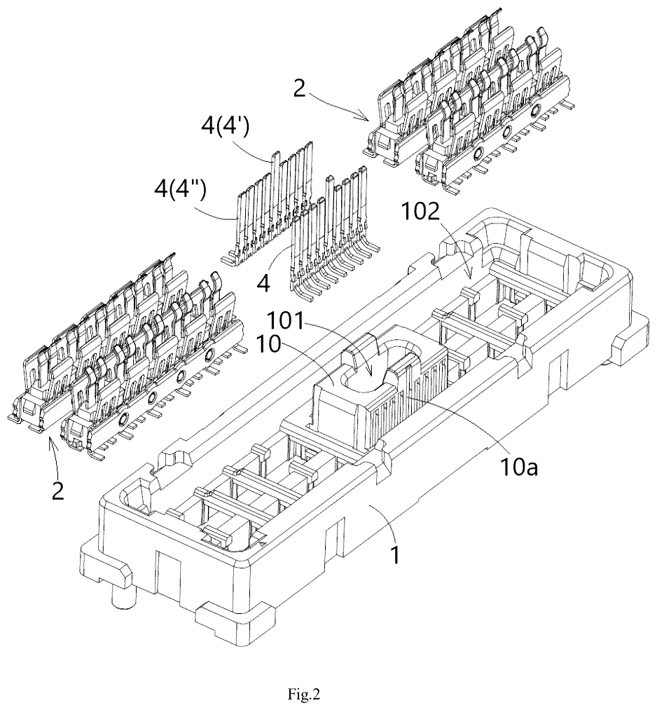

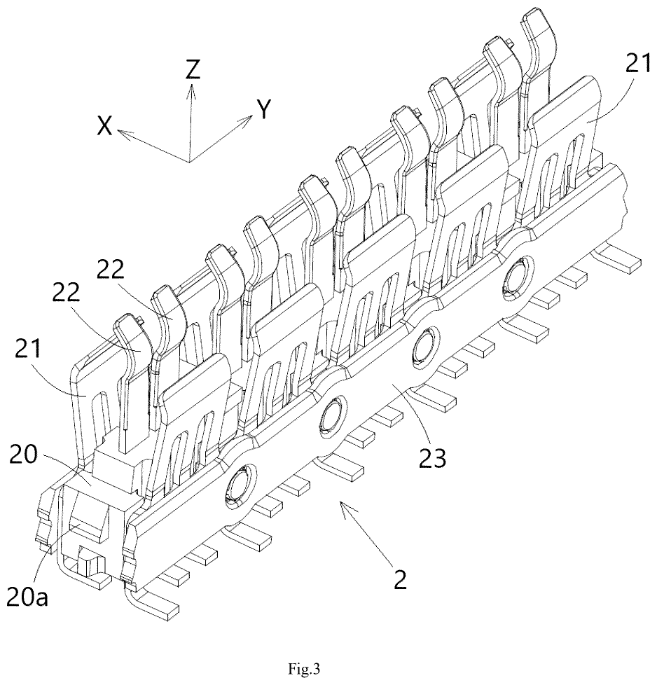

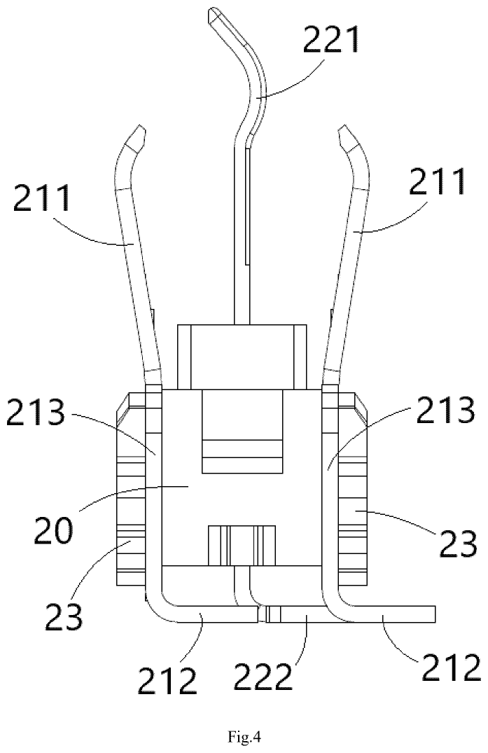

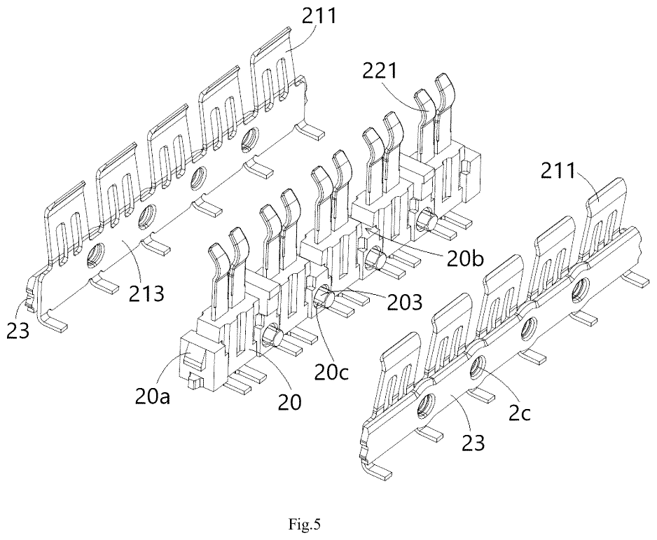

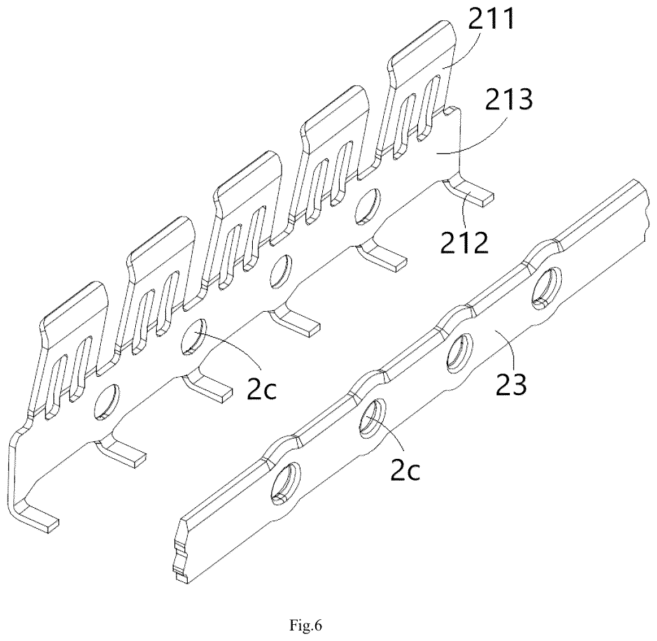

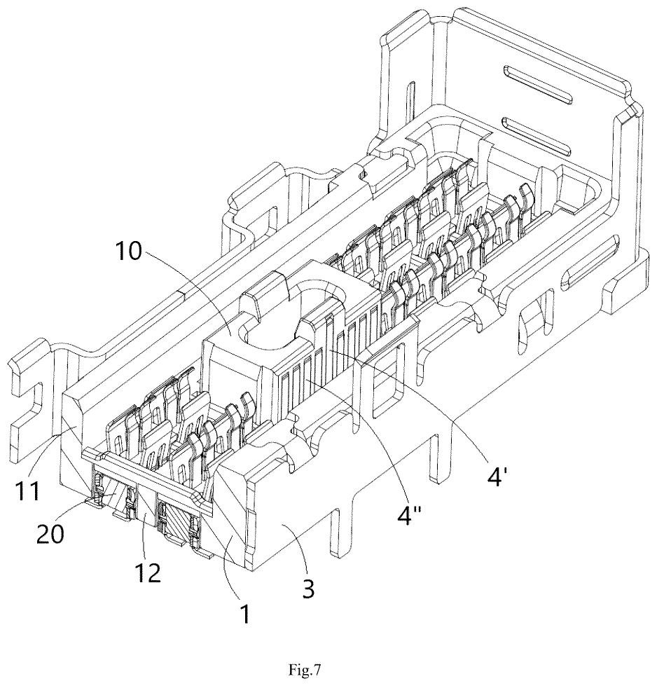

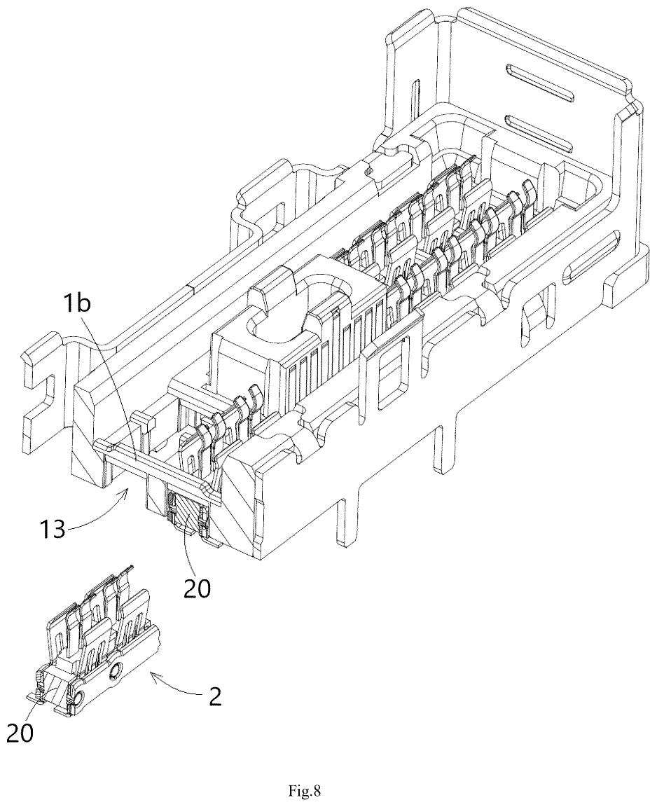

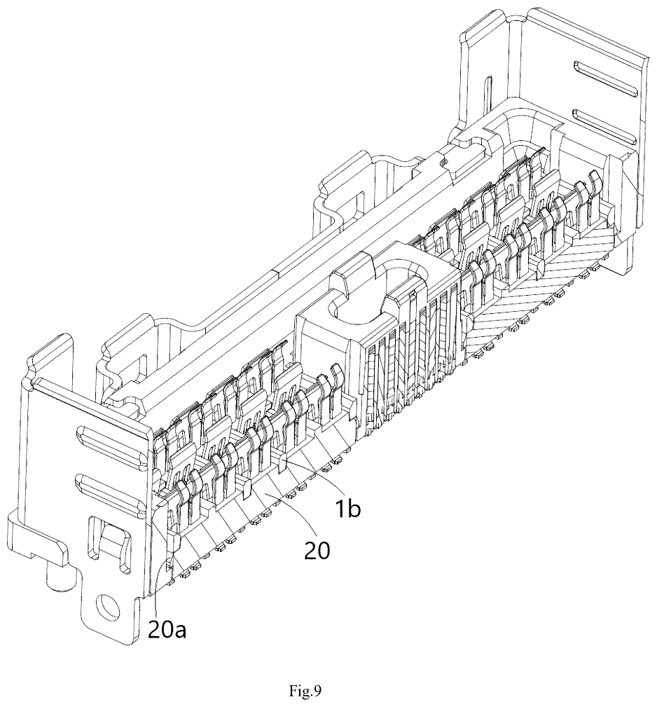

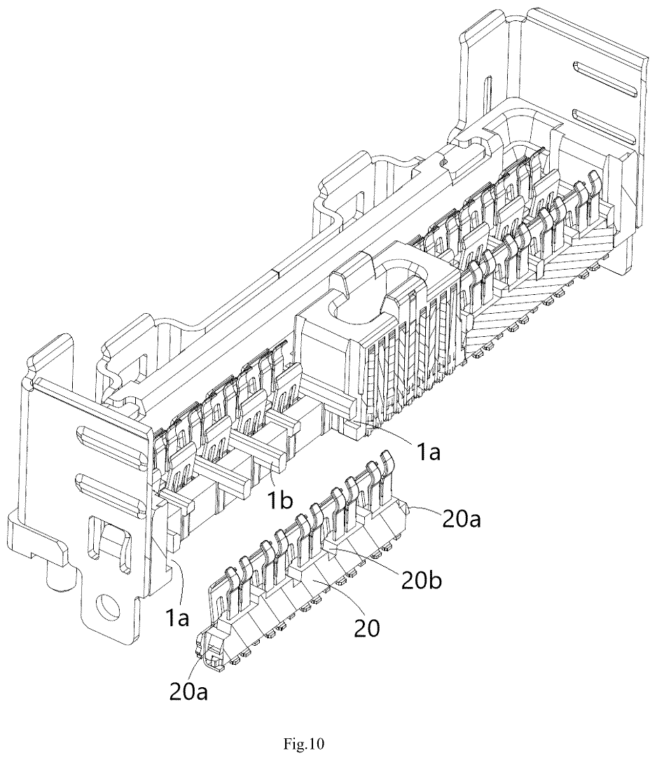

FIG. 1 shows a three-dimensional schematic diagram of a connector 100 according to an exemplary embodiment of the present invention; FIG. 2 shows an exploded schematic diagram of connector 100 according to an exemplary embodiment of the present invention, without display screen cover 3; FIG. 3 shows a three-dimensional schematic diagram of terminal module 2 of connector 100 according to an exemplary embodiment of the present invention; FIG. 4 shows a schematic plan view of terminal module 2 of connector 100, as viewed from one end, according to an exemplary embodiment of the present invention; FIG. 5 shows an exploded schematic diagram of terminal module 2 of connector 100 according to an exemplary embodiment of the present invention; FIG. 6 shows an exploded schematic diagram of the grounding element 21 and reinforcement strip 23 of the terminal module 2 of the connector 100 according to an exemplary embodiment of the present invention; FIG. 7 shows a transverse cross-sectional view of terminal module 2 of connector 100 according to an exemplary embodiment of the present invention; FIG. 8 shows a transverse exploded sectional view of terminal module 2 of connector 100 according to an exemplary embodiment of the present invention; FIG. 9 shows a longitudinal sectional view of terminal module 2 of connector 100 according to an exemplary embodiment of the present invention; FIG. 10 shows a longitudinal exploded sectional view of terminal module 2 of connector 100 according to an exemplary embodiment of the present invention.

As shown in FIGS. 1 to 10, in an exemplary embodiment of the present invention, a terminal module 2 is disclosed. The terminal module 2, as shown in FIG. 3, includes an insulator 20, a pair of grounding components 21, and multiple pairs of high-speed signal terminals 22. A pair of grounding components 21 are fixed to the insulator 20 and spaced opposite each other in the width direction X of the insulator 20. Multiple pairs of high-speed signal terminals (i.e., high-speed differential signal terminal pairs) 22 are fixed to the insulator 20 and arranged in a row along the length direction Y of the insulator 20. A row of high-speed signal terminals 22 are located between a pair of grounding components 21 and are spaced apart from the grounding components 21 by a predetermined distance in the width direction X. The grounding component 21 includes multiple grounding spring pieces 211 corresponding to multiple pairs of high-speed signal terminals 22. Multiple grounding springs 211 are arranged in a row along the length direction Y of the insulator 20. The high-speed signal terminal 22 has a contact spring arm 221, and the contact spring arm 221 of each pair of high-speed signal terminals 22 is located between a pair of ground spring pieces 211 that are opposite in the width direction X, as shown in FIG. 4.

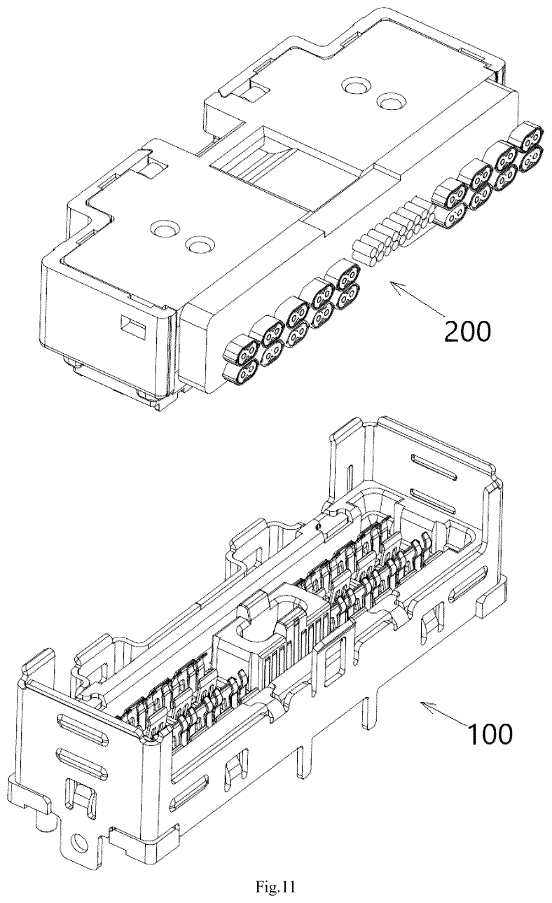

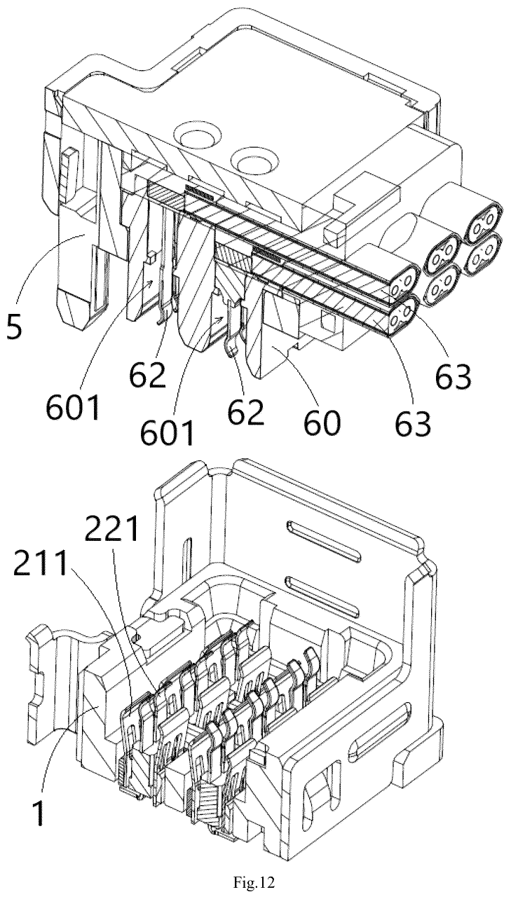

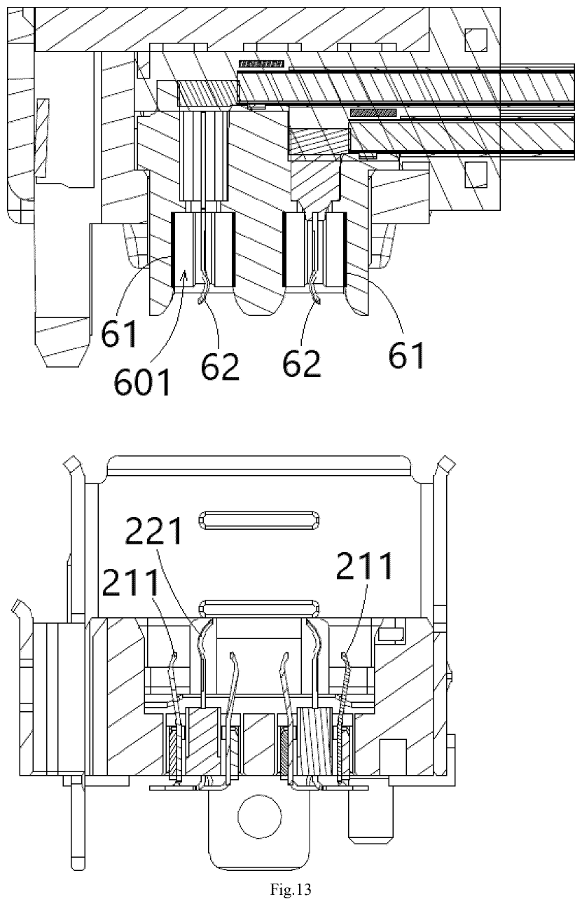

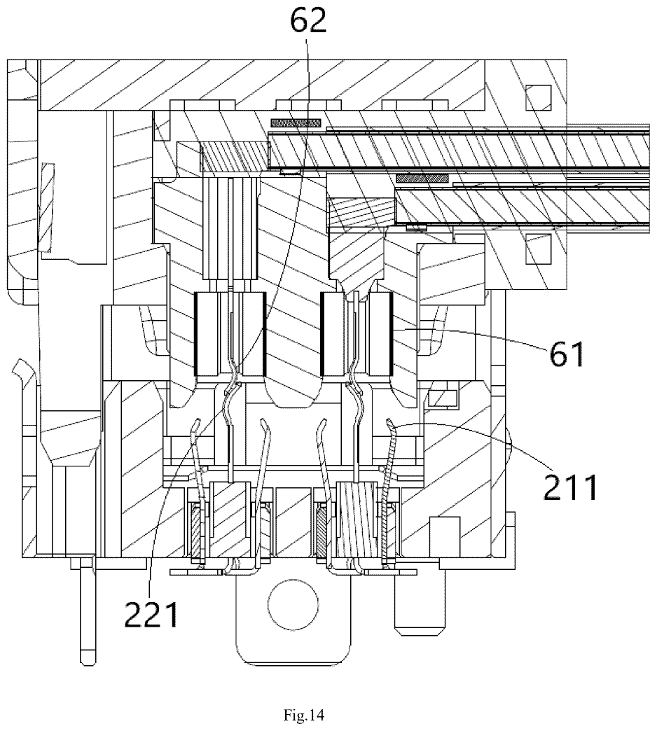

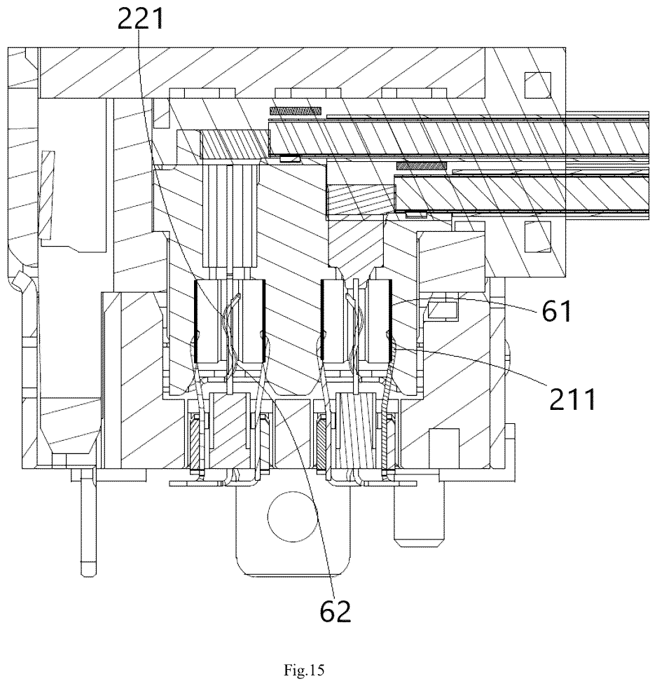

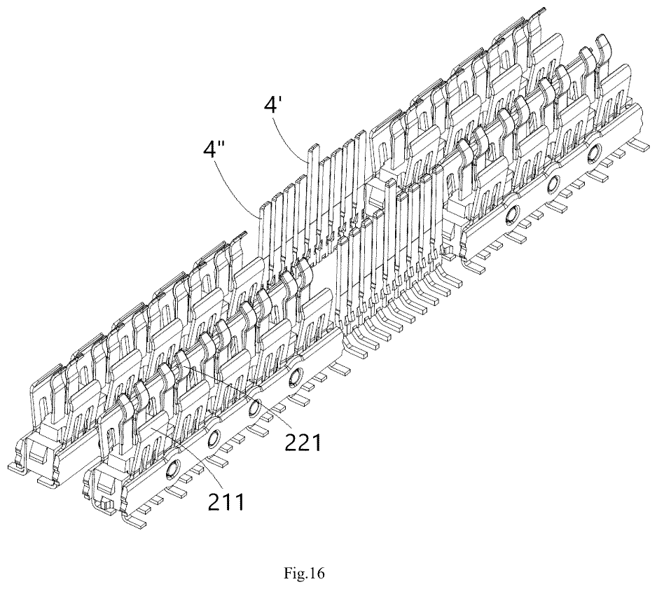

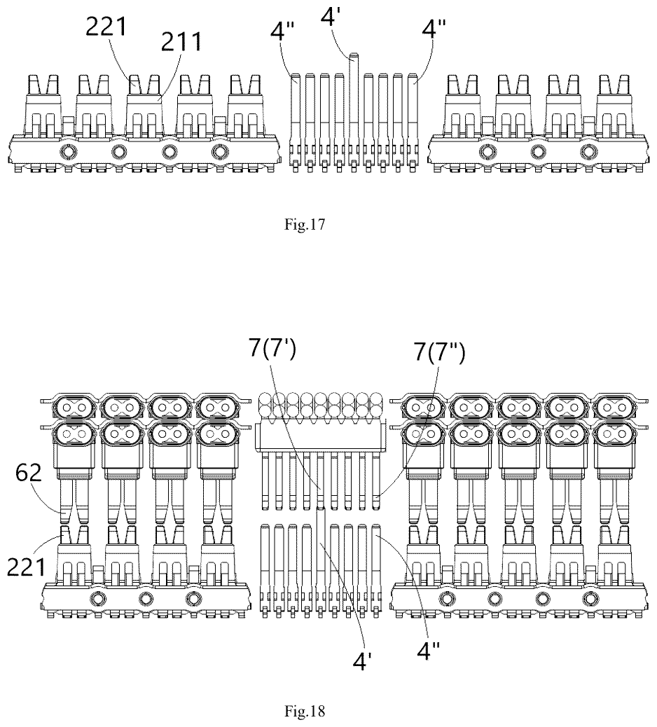

FIG. 11 shows a three-dimensional schematic diagram of connector 100 and mating connector 200 according to an exemplary embodiment of the present invention; FIG. 12 shows a perspective sectional view of connector 100 and mating connector 200 according to an exemplary embodiment of the present invention; FIG. 13 shows a plan sectional view of connector 100 and mating connector 200 according to an exemplary embodiment of the present invention; FIG. 14 shows a planar cross-sectional view of a connector 100 and a mating connector 200 according to an exemplary embodiment of the present invention, where the high-speed signal terminal 22 has just made electrical contact with the high-speed mating signal terminal 62, and the grounding spring 211 has not yet made electrical contact with the conductive shield 61; FIG. 15 shows a plan sectional view of connector 100 and mating connector 200 according to an exemplary embodiment of the present invention, where connector 100 and mating connector 200 have been mated together; FIG. 16 shows a three-dimensional schematic diagram of the high-speed signal terminal 22 and the low-speed signal terminal 4 of the connector 100 according to an exemplary embodiment of the present invention; FIG. 17 shows a schematic plan view of the high-speed signal terminal 22 and low-speed signal terminal 4 of connector 100 according to an exemplary embodiment of the present invention; FIG. 18 shows a schematic plan view of the high-speed signal terminal 22 and low-speed signal terminal 4 of connector 100, as well as the high-speed matching signal terminal 62 and low-speed matching signal terminal 7 of mating connector 200, according to an exemplary embodiment of the present invention. The first low-speed signal terminal 4′ and the first low-speed matching signal terminal 7′ for electrostatic discharge protection have just made contact, while the signal terminals for other functions have not yet made electrical contact.

As shown in FIG. 4, in the illustrated embodiment, the grounding spring 211 of the grounding element 21 and the contact spring arm 221 of the high-speed signal terminal 22 extend upward from the top of the insulator 20, for electrical contact with the conductive shield 61 of the mating terminal module 6 of the mating connector 200 and the high-speed mating signal terminal 62, respectively. The length of the upward extension of the contact spring arm 221 is greater than that of the grounding spring plate 211, so that during the process of matching the terminal module 2 with the matching terminal module 6, the contact spring arm 221 makes electrical contact with the high-speed matching signal terminal 62 before the grounding spring plate 211 makes electrical contact with the conductive shield 61.

In the illustrated embodiment, the insulator 20 is injection molded onto multiple pairs of high-speed signal terminals 22, so that the insulator 20 and the multiple pairs of high-speed signal terminals 22 become an integrated piece.

The grounding member 21 also has a fixing strip 213 extending along the length direction Y of the insulator 20, as shown in FIGS. 4 to 6, and the insulator 20 has two opposite sides in its width direction X. A pair of fixing strips 213 of the grounding member 21 are respectively fixed to both sides of the insulator 20. As shown in FIGS. 5 and 6, in the illustrated embodiment, the fixing strip 213 has upper and lower sides opposite to each other in the height direction Z of the insulator 20, and a row of grounding spring pieces 211 of the grounding member 21 is connected to the upper side of the fixing strip 213.

As shown in FIGS. 4 and 6, in the illustrated embodiment, the grounding member 21 also has multiple grounding pins 212 located at the bottom of the insulator 20. The multiple grounding pins 212 are arranged in a row along the length direction Y of the insulator 20 and connected to the lower side edge of the fixing strip 213. The high-speed signal terminal 22 has high-speed signal solder pins 222 exposed from the bottom of the insulator 20, and the high-speed signal solder pins 222 and the ground solder pins 212 are suitable for surface mount soldering to a circuit board.

As shown in FIGS. 3 to 5, in the illustrated embodiment, terminal module 2 also includes a pair of reinforcing bars 23. A pair of reinforcing bars 23 are welded to the fixing bars 213 of a pair of grounding components 21 to increase the strength of the fixing bars 213 of the grounding components 21. The inner side of the fixing strip 213 of the grounding element 21 is pressed against the insulator 20, and the reinforcing strip 23 is welded to the outer side of the fixing strip 213 of the grounding element 21.

As shown in FIG. 5, in the illustrated embodiment, multiple protruding pillars 203 are formed on both sides of the insulator 20, and the multiple protruding pillars 203 are arranged in a row along the length direction Y of the insulator 20. Multiple insertion holes 2c are respectively formed on the fixed strip 213 and the reinforcing strip 23, and multiple protruding posts 203 are engaged with multiple insertion holes 2c to fix the grounding member 21 to the insulator 20.

As shown in FIG. 5, in the illustrated embodiment, multiple convex ribs 20C are formed on the protruding column 203, which extend along the axial direction of the protruding column 203 and are distributed at intervals in the circumferential direction of the protruding column 203. The multiple protruding ribs 20C on the protruding column 203 are in interference fit with the hole wall of the insertion hole 2c to fix the protruding column 203 into the insertion hole 2c. In the illustrated embodiment, the insulator 20 has two opposite ends in its length direction Y, and protrusions 20a are formed at each end of the insulator 20. The protrusions 20a are used to engage with the slots 1a inside the insulation shell 1 of the connector 100, as shown in FIG. 10, to lock the terminal module 2 in the insulation shell 1.

As shown in FIG. 10, in the illustrated embodiment, a positioning groove 20b extending along its width direction X is formed at the top of the insulator 20, which is used to engage with the positioning rib 1b inside the insulation shell 1 of the connector 100 to position the terminal module 2 in the insulation shell 1.

In the illustrated embodiment, the grounding component 21 is an integral stamped part.

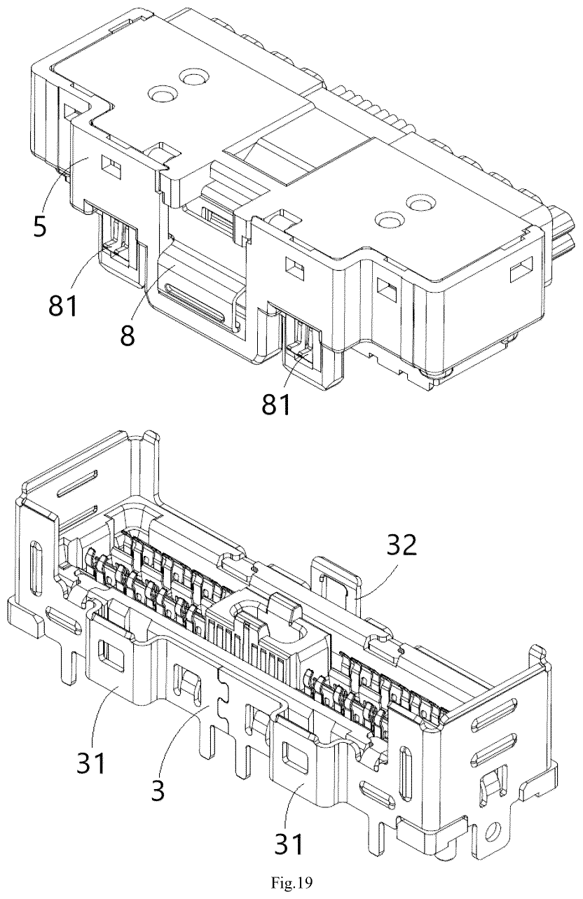

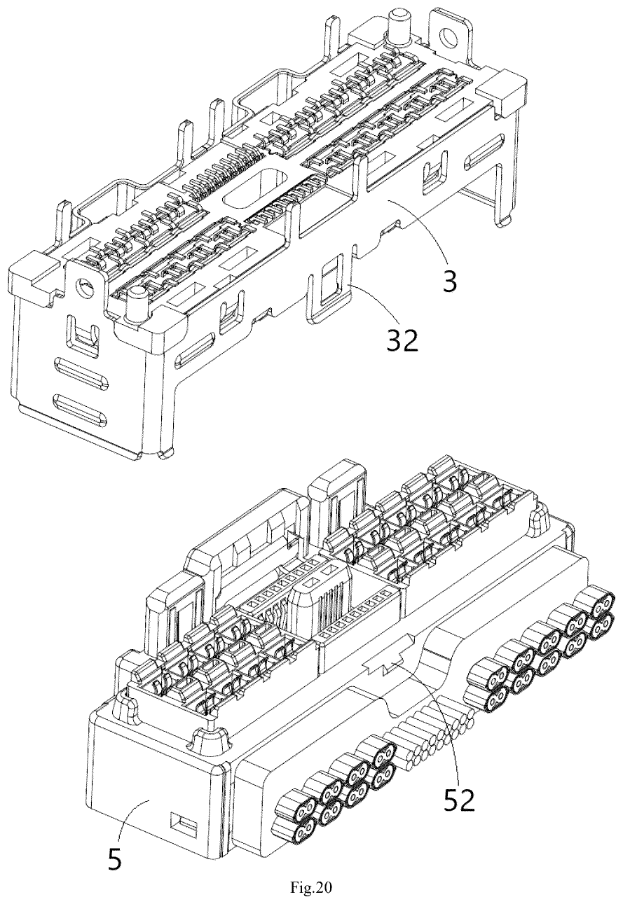

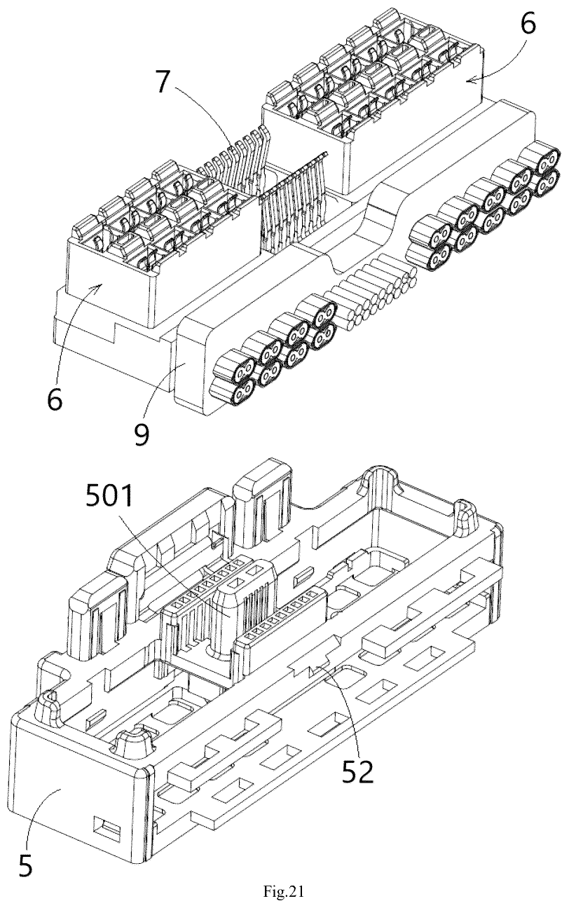

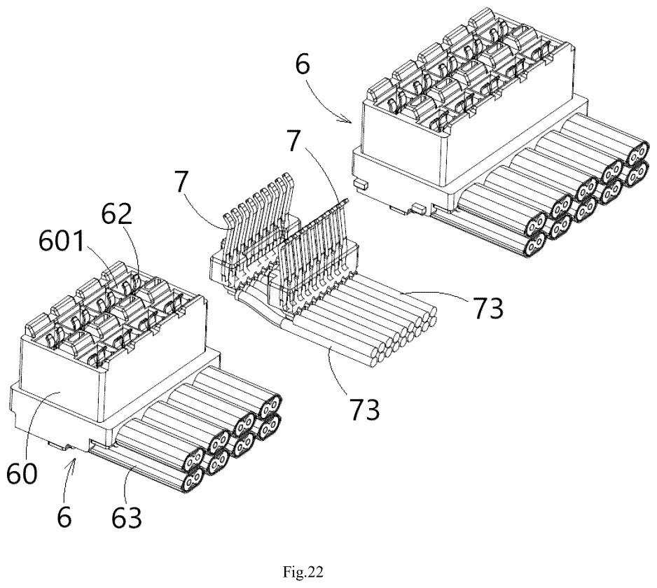

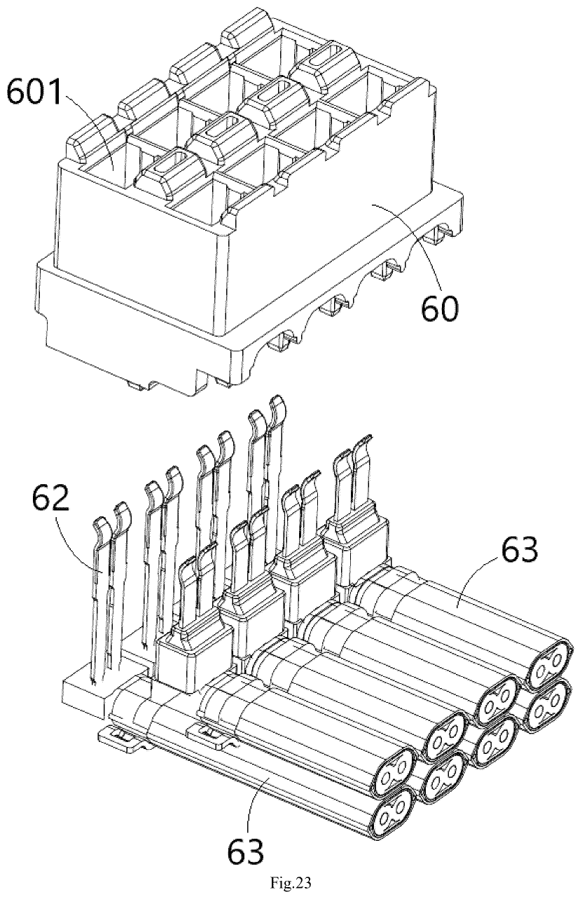

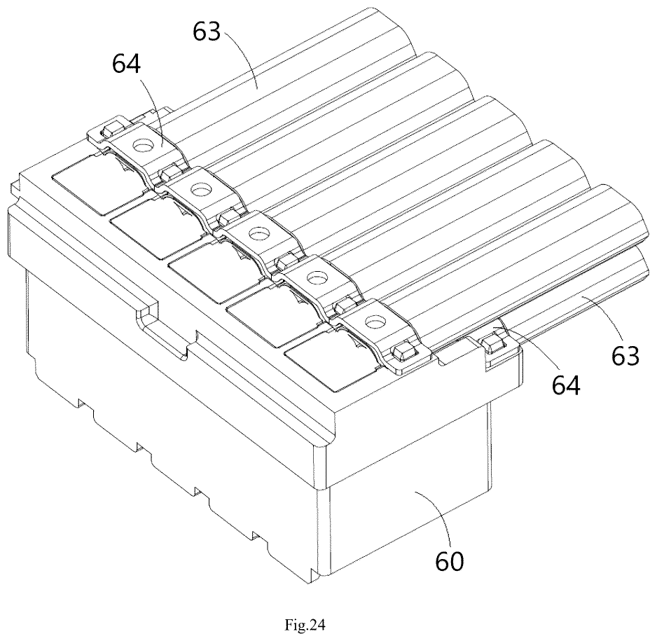

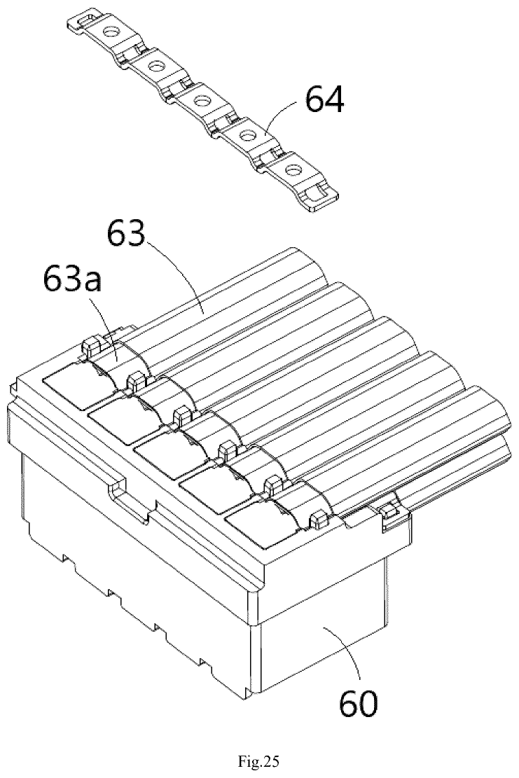

FIG. 19 shows a perspective view of connector 100 and mating connector 200 according to an exemplary embodiment of the present invention when viewed from the front side; FIG. 20 shows a three-dimensional schematic diagram of connector 100 and mating connector 200 according to an exemplary embodiment of the present invention when viewed from the rear; FIG. 21 shows an exploded schematic diagram of a mating connector 200 according to an exemplary embodiment of the present invention; FIG. 22 shows a three-dimensional schematic diagram of the mating terminal module 6 and low-speed signal terminal module of the mating connector 200 according to an exemplary embodiment of the present invention; FIG. 23 shows an exploded schematic diagram of the mating terminal module 6 of the mating connector 200 according to an exemplary embodiment of the present invention; FIG. 24 shows a three-dimensional schematic diagram of the mating terminal module 6 of the mating connector 200 according to an exemplary embodiment of the present invention when viewed from the back; FIG. 25 shows a three-dimensional schematic diagram of the mating terminal module 6 of the mating connector 200 according to an exemplary embodiment of the present invention when viewed from the back, where one shielding connector 64 has not yet been soldered to the shielding layer 12c of a row of high-speed signal cables 63.

As shown in FIG. 1, in another exemplary embodiment of the present invention, a connector 100 is also disclosed. The connector 100 includes an insulation shell 1 and the aforementioned terminal module 2. Terminal module 2 is installed into insulation shell 1. As shown in FIG. 2, in the illustrated embodiment, connector 100 also includes multiple low-speed signal terminals 4. Multiple low-speed signal terminals 4 are arranged in the insulation shell 1 for electrical contact with the low-speed matching signal terminals 7 of the matching connector 200.

As shown in FIG. 7, in the illustrated embodiment, the insulation shell 1 includes a peripheral wall 11 and a bottom wall 12 enclosing an inner cavity 102, and a retaining body 10 located in the inner cavity 102 and connected to the bottom wall 12. The retaining body 10 has front and rear sides opposite to each other in the width direction X of the insulation shell 1. Multiple low-speed signal terminals 4 are arranged in two rows and fixed to the front and rear sides of the holding body 10, respectively.

As shown in FIG. 2, in the illustrated embodiment, multiple terminal slots 10a are formed on the front and rear sides of the holding body 10, and the low-speed signal terminal 4 is installed in the terminal slots 10a. In the illustrated embodiment, each row of low-speed signal terminals 4 includes a first low-speed signal terminal 4′ and multiple second low-speed signal terminals 4′, and multiple second low-speed signal terminals 4′ are symmetrically arranged on the left and right sides of a first low-speed signal terminal 4′.

In the illustrated embodiment, each row of low-speed signal terminals 4 includes a first low-speed signal terminal 4′ for electrostatic discharge protection and a second low-speed signal terminal 4″ with a function different from the first low-speed signal terminal 4′. The extension length of the first low-speed signal terminal 4′ in the height direction Z of the insulation shell 1 is greater than that of the second low-speed signal terminal 4″, as shown in FIG. 2. During the process of mating connector 100 with mating connector 200, the first low-speed signal terminal 4′ makes electrical contact with the first low-speed mating signal terminal 7′ of mating connector 200 before the second low-speed signal terminal 4″ makes electrical contact with the second low-speed mating signal terminal 7″ of mating connector 200.

As shown in FIGS. 11 to 25, in the illustrated embodiment, during the mating process between connector 100 and mating connector 200, the first low-speed signal terminal 4′ makes electrical contact with the first low-speed mating signal terminal 7′ before the high-speed signal terminal 22 makes electrical contact with the high-speed mating signal terminal 62 of mating connector 200.

As shown in FIG. 1, in the illustrated embodiment, the retaining body 10 is located in the middle region of the insulating shell 1 and has left and right sides opposite in the length direction Y of the insulating shell 1. The insulating shell 1 has a left side region located on the left side of the retaining body 10 and a right side region located on the right side of the retaining body 10. The connector 100 includes multiple terminal modules 2, which are respectively installed in the left and right regions of the insulation shell 1.

As shown in FIG. 2, in the illustrated embodiment, the connector 100 includes two terminal modules 2 installed in the left area of the insulation shell 1 and two terminal modules 2 installed in the right area of the insulation shell 1. The two terminal modules 2 in the left area of the insulation shell 1 are arranged side by side in the width direction X of the insulation shell 1, and the two terminal modules 2 in the right area of the insulation shell 1 are arranged side by side in the width direction X of the insulation shell 1.

As shown in FIG. 8, in the illustrated embodiment, a mounting groove 13 extending along the length direction Y of the insulation shell 1 is formed on the bottom wall 12 of the insulation shell 1. The insulator 20 of the terminal module 2 is embedded in the mounting groove 13, and the contact spring arm 221 of the high-speed signal terminal 22 and the grounding spring 211 of the grounding piece 21 are located in the inner cavity 102 of the insulation shell 1.

As shown in FIGS. 9 and 10, in the illustrated embodiment, card slots 1a are formed on the inner walls of both ends of the installation slot 13 of the insulation shell 1. The card slots 1a are engaged with the protrusions 20a on the insulator 20 of the terminal module 2 to lock the terminal module 2 in the insulation shell 1.

As shown in FIGS. 8 to 10, in the illustrated embodiment, a positioning rib 1b spanning the installation groove 13 is formed in the insulation shell 1, and the positioning rib 1b is engaged with the positioning groove 20b on the insulator 20 of the terminal module 2 to position the terminal module 2 in the insulation shell 1.

As shown in FIG. 2, in the illustrated embodiment, a positioning hole 101 is formed in the retaining body 10 of the insulating shell 1. The positioning hole 101 is used to mate with the positioning column 501 on the mating housing 5 of the mating connector 200, shown in FIG. 21, to guide the connector 100 to mate with the mating connector 200.

As shown in FIG. 1, in the illustrated embodiment, the connector 100 further comprises a shielding shell 3, which is fitted onto the insulating shell 1 and has front and rear sides opposite to each other in the width direction X of the insulating shell 1. A front buckle 31 is formed on the front side of the shielding shell 3, which is used to engage with the elastic hook 81 on the locking piece 8 of the mating connector 200. A rear buckle 32 is formed on the rear side of the shielding shell 3, which is used to engage with the locking protrusion 52 on the mating housing 5 of the mating connector 200. In the illustrated embodiment, the insulation shell 1 is an integrated injection molded part, and the shielding shell 3 is an integrated stamping molded part.

As shown in FIG. 1, in the illustrated embodiment, the shielding shell 3 has a soldering leg 33 located at the bottom of the insulating shell 1, which is used for insertion and soldering into a socket on a circuit board.

As shown in FIGS. 22 and 23, in another exemplary embodiment of the present invention, a paired terminal module 6 is also disclosed. The paired terminal module 6 includes a paired insulator 60, multiple pairs of high-speed paired signal terminals 62, and a conductive shield 61. The mating insulator 60 has multiple slots 601. Multiple pairs of high-speed pairing signal terminals 62 are respectively set in multiple slots 601. Conductive shield 61 is set into slot 601. The mating terminal module 6 is used to mate with the aforementioned terminal module 2, the contact spring arm 221 of the high-speed signal terminal 22 is used to make electrical contact with the high-speed mating signal terminal 62, and the grounding spring 211 of the grounding element 21 is used to make electrical contact with the conductive shield 61.

As shown in FIGS. 12 to 15 and 22, in the illustrated embodiment, the conductive shield 61 includes a conductive layer electroplated onto the inner wall surface of the slot 601 of the mating insulator 60. In another embodiment, the conductive shield 61 includes a conductive plate installed into the slot 601 of the mating insulator 60.

As shown in FIG. 12 and 22 to 25, in the illustrated embodiment, the mating terminal module 6 also includes multiple high-speed signal cables 63. Multiple high-speed signal cables 63 are electrically connected to multiple pairs of high-speed paired signal terminals 62. The shielding layer 63a of the high-speed signal cable 63 is electrically connected to the conductive shield 61.

As shown in FIG. 23, in the illustrated embodiment, multiple slots 601 on the mating insulator 60 are arranged in two rows, multiple pairs of high-speed mating signal terminals 62 are arranged in two rows, multiple high-speed signal cables 63 are arranged in two rows, and the mating terminal module 6 is used to mate with the two terminal modules 2 arranged side by side.

As shown in FIGS. 24 and 25, in the illustrated embodiment, the mating terminal module 6 also includes two shielding connectors 64. Two shielding connectors 64 are respectively welded to the shielding layer 63a of two rows of high-speed signal cables 63 and welded to the conductive shield 61 to electrically connect the shielding layer 63a of the high-speed signal cable 63 to the conductive shield 61. In the illustrated embodiment, the shielding connector 64 is an integral stamped part.

As shown in FIGS. 11 and 12, in another exemplary embodiment of the present invention, a mating connector 200 is also disclosed. The mating connector 200 includes a mating housing 5 and the aforementioned mating terminal module 6. The matching terminal module 6 is installed in the matching housing 5. The mating connector 200 is used to mate with the aforementioned connector 100.

As shown in FIG. 21, in the illustrated embodiment, the mating housing 5 includes an outer peripheral wall enclosing a receiving cavity and a positioning column 501 located in the receiving cavity and connected to the outer peripheral wall. The positioning column 501 is used to mate with the positioning hole 101 on the retaining body 10 of the connector 100 to guide the connector 100 to mate with the mating connector 200.

In an embodiment, the mating connector 200 further comprises a low-speed signal terminal module arranged in the mating housing 5, which includes multiple low-speed mating signal terminals 7, shown in FIG. 22. Multiple low-speed pairing signal terminals 7 are arranged in the pairing housing 5 for electrical contact with the multiple low-speed signal terminals 4 of the connector 100.

As shown in FIGS. 18, 21, and 22, in the illustrated embodiment, multiple low-speed pairing signal terminals 7 are arranged in two rows, and each row of low-speed pairing signal terminals 7 includes a first low-speed pairing signal terminal 7′ and a second low-speed pairing signal terminal 7″. The first low-speed pairing signal terminal 7′ is used for electrostatic discharge protection and is suitable for electrical contact with the first low-speed signal terminal 4′ of connector 100. The function of the second low-speed pairing signal terminal 7″ is different from that of the first low-speed pairing signal terminal 7′ and is suitable for electrical contact with the second low-speed signal terminal 4″ of connector 100.

As shown in FIG. 22, in the illustrated embodiment, the low-speed signal terminal module of the mating connector 200 further includes multiple low-speed signal cables 73, which are respectively electrically connected to multiple low-speed mating signal terminals 7.

As shown in FIG. 21, in the illustrated embodiment, the mating connector 200 further comprises a cable retaining body 9, which is injection molded onto multiple low-speed signal cables 73 and multiple high-speed signal cables 63 of the mating connector 200.

As shown in FIG. 19, in the illustrated embodiment, the mating connector 200 further comprises a locking member 8, which is mounted on the mating housing 5 and has an elastic hook 81. The elastic hook 81 is located on the front side of the mating housing 5 and is used to engage with the front buckle 31 on the front side of the shielding housing 3 of the connector 100. A locking protrusion 52 is formed on the rear side of the mating housing 5, shown in FIG. 20, which is used to engage with the rear buckle 32 on the rear side of the shielding shell 3 of the connector 100.

As shown in FIG. 19, in the illustrated embodiment, the elastic hook 81 is adapted to move between a locked position engaged with the front buckle 31 and an unlocked position separated from the front buckle 31. The mating connector 200 also includes an unlocking strap, which is connected to the locking element 8 and used to drive the elastic hook 81 to move between the locking position and the unlocking position.

In the aforementioned exemplary embodiments according to the present invention, one row of high-speed signal terminals in the terminal module is located between two rows of grounding springs, and the contacts of the grounding springs are not in the same row as the contacts of the high-speed signal terminals. Therefore, the present invention can effectively suppress resonance and noise coupling between adjacent pairs of high-speed signal terminals, reducing signal crosstalk.

In the aforementioned exemplary embodiments according to the present invention, the two rows of grounding springs in the terminal module are in electrical contact with the conductive shielding in the mating insulator of the mating terminal module, thereby forming a grounding circuit and improving the electromagnetic shielding effect of the connector product. In addition, the conductive shielding in the paired insulator can effectively suppress the noise coupling between adjacent pairs of high-speed signal terminals and reduce signal crosstalk.

In the aforementioned exemplary embodiments according to the present invention, the low-speed signal terminals are arranged in the middle area of the connector, and the high-speed signal terminals are respectively arranged on the left and right sides of the middle area of the connector. This layout can optimize the impedance consistency of the signal transmission path and meet the requirements of higher signal transmission rate and lower fitting height.

In the aforementioned exemplary embodiments according to the present invention, the connector and the mating connector are matched with positioning posts and positioning holes to ensure smooth mating between the connector and the mating connector. In addition, the front and rear sides of the shielding shell of the connector are respectively formed with front and rear buckles that engage with the mating connector, which can reliably lock the connector and the mating connector together.

In the aforementioned exemplary embodiments according to the present invention, the extension length of the contact spring arm of the high-speed signal terminal of the connector is greater than the extension length of the grounding spring. Therefore, the contact spring arm makes electrical contact with the high-speed mating signal terminal before the grounding spring contacts the conductive shield, thereby reducing the mating force between the connector and the mating connector during mating.

In the aforementioned exemplary embodiments according to the present invention, the extension length of the electrostatic discharge protection terminal in the low-speed signal terminal of the connector is greater than that of the signal terminals of other functions. Therefore, the electrostatic discharge protection terminal can make electrical contact with the mating signal terminal before the signal terminals of other functions, providing effective electrostatic discharge protection for the connector product and improving its safety during use.

In the aforementioned exemplary embodiments according to the present invention, a reinforcing strip is welded to the fixing strip of the grounding member, thereby improving the strength of the grounding member without increasing the thickness of the grounding spring. Thinner grounding spring can improve the signal integrity of the connector product and reduce the insertion and extraction force.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A terminal module comprising:
an insulator;
a pair of grounding components fixed to the insulator and spaced opposite each other in a width direction of the insulator; and
a plurality of pairs of high-speed signal terminals fixed to the insulator and arranged in a row along a length direction of the insulator, a row of the high-speed signal terminals is located between the pair of grounding components and is spaced apart from the grounding components by a predetermined distance in the width direction, each of the grounding components includes a plurality of grounding spring pieces corresponding to the plurality of pairs of high-speed signal terminal, the grounding spring pieces are arranged in a row along the length direction of the insulator, each of the high-speed signal terminals has a contact spring arm located between a pair of the plurality of grounding spring pieces that are opposite each other in the width direction.

2. The terminal module according to claim 1, wherein the grounding spring pieces and the contact spring arms extend upward from a top of the insulator to electrically contact a conductive shield of a mating terminal module and a high-speed mating signal terminal of a mating connector, a length of an upward extension of the contact spring arms is greater than a length of an upward extension of the grounding spring pieces, so that the contact spring arms electrically contact the high-speed mating signal terminal before the grounding spring pieces contact the conductive shield.

3. The terminal module according to claim 1, wherein the insulator is injection molded onto the plurality of pairs of high-speed signal terminals, the insulator and the plurality of pairs of high-speed signal terminals are an integrated piece.

4. The terminal module according to claim 1, wherein the grounding member has a pair of fixing strips extending along the length direction, each of the fixing strips is fixed to one of a pair of sides of the insulator opposite each other in the width direction.

5. The terminal module according to claim 4, wherein each of the fixing strips has an upper side and a lower side opposite each other in a height direction, the row of grounding spring pieces are connected to the upper side of the fixing strips.

6. The terminal module according to claim 5, wherein each of the grounding components has a plurality of grounding pins at a bottom of the insulator, the grounding pins are arranged in a row in the length direction and connected to the lower side of one of the fixing strips, the high-speed signal terminals have a plurality of high-speed signal solder pins exposed from the bottom of the insulator, the high-speed signal solder pins and the grounding pins are suitable for surface mount soldering to a circuit board.

7. The terminal module according to claim 5, further comprising a pair of reinforcing bars respectively welded to the fixing strips, an inner side of each of the fixing strips is attached to the insulator and the reinforcing bars are welded to an outer side of each of the fixing strips.

8. The terminal module according to claim 7, wherein the insulator has a plurality of protruding pillars arranged in a row along the length direction, the fixing strips and the reinforcing bars have a plurality of insertion holes receiving the protruding pillars to fix the grounding components to the insulator.

9. The terminal module according to claim 8, wherein each of the protruding pillars has a plurality of convex ribs extending along an axial direction and distributed at intervals in a circumferential direction of the protruding pillar, the convex ribs are interference fit with the insertion holes.

10. The terminal module according to claim 1, wherein each of the grounding components is an integrated stamped and formed part.

11. A connector, comprising:
an insulation shell; and
a terminal module installed in the insulation shell, the terminal module includes:
an insulator;
a pair of grounding components fixed to the insulator and spaced opposite each other in a width direction of the insulator; and
a plurality of pairs of high-speed signal terminals fixed to the insulator and arranged in a row along a length direction of the insulator, a row of the high-speed signal terminals is located between the pair of grounding components and is spaced apart from the grounding components by a predetermined distance in the width direction, each of the grounding components includes a plurality of grounding spring pieces corresponding to the plurality of pairs of high-speed signal terminal, the grounding spring pieces are arranged in a row along the length direction of the insulator, each of the high-speed signal terminals has a contact spring arm located between a pair of the plurality of grounding spring pieces that are opposite each other in the width direction.

12. The connector according to claim 11, wherein the insulator has a pair of opposite ends in the length direction, a protrusion is formed at each of the pair of opposite ends of the insulator and engages with a slot in the insulation shell to lock the terminal module in the insulation shell.

13. The connector according to claim 11, wherein a top of the insulator has a positioning groove extending along the width direction, the positioning groove engages with a positioning rib inside the insulation shell to position the terminal module in the insulation shell.

14. The connector according to claim 13, further comprising a plurality of low-speed terminals arranged in the insulation shell.

15. The connector according to claim 14, wherein the insulation shell has a peripheral wall and a bottom wall enclosing an inner cavity, a retaining body is located in the inner cavity and connected to the bottom wall, the low-speed terminals are arranged in a pair of rows and fixed to a front side and a rear side of the retaining body.

16. An assembly, comprising:
a terminal module including an insulator, a pair of grounding components fixed to the insulator and spaced opposite each other in a width direction of the insulator, and a plurality of pairs of high-speed signal terminals fixed to the insulator and arranged in a row along a length direction of the insulator, a row of the high-speed signal terminals is located between the pair of grounding components and is spaced apart from the grounding components by a predetermined distance in the width direction, each of the grounding components includes a plurality of grounding spring pieces corresponding to the plurality of pairs of high-speed signal terminal, the grounding spring pieces are arranged in a row along the length direction of the insulator, each of the high-speed signal terminals has a contact spring arm located between a pair of the plurality of grounding spring pieces that are opposite each other in the width direction; and
a mating terminal module including a mating insulator having a plurality of slots, a plurality of pairs of high-speed paired signal terminals positioned in the slots, and a conductive shield installed in the slots, the mating terminal module is matable with the terminal module, the contact spring arms of the high-speed terminals electrically contact the high-speed paired signal terminals and the grounding spring pieces of the grounding components electrically contact the conductive shield.

17. The assembly according to claim 16, wherein the conductive shield is:
a conductive layer electroplated on an inner wall surface of each of the slots of the mating insulator; or
a conductive plate installed in each of the slots of the mating insulator.

18. The assembly according to claim 16, further comprising a plurality of high-speed cables electrically connected to the plurality of pairs of high-speed paired signal terminals, a shielding layer of each of the high-speed cables is electrically connected to the conductive shield.

19. The assembly according to claim 18, wherein the slots of the mating insulator are arranged in a pair of rows, the plurality of pairs of high-speed paired signal terminals are arranged in two rows, the high-speed cables are arranged in two rows, and the mating terminal module mates with a pair of terminal modules arranged side by side.

20. The assembly according to claim 19, further comprising a shielding connector welded to the shielding layers of the high-speed cables and welded to the conductive shield to electrically connect the shielding layers to the conductive shield.
